(19) United States
(12) Patent Application Publication
(10) Pub. No.: US 2021/0400928 A1
(43) Pub. Date: Dec. 30, 2021

(54) CORAL FRAG RETENTION SYSTEM

(71) Applicant: Ryan Snodgrass, Lynd, MN (US)

(72) Inventor: Ryan Snodgrass, Lynd, MN (US)

(21) Appl. No.: 16/910,063

(22) Filed: Jun. 24, 2020

(51) Int. Cl. A01K 63/00; A01K 61/30; A01K 63/02

(52) U.S. Cl. CPC A01K 63/006; A01K 61/77; A01K 63/02; A01K 61/30

(57) ABSTRACT

A coral holder which either resides in an aquarium or in a transport container. The coral holder may be either a fixed object or an insert. The coral holder has one or more coral channels, preferably elongated channels, which accept corals or coral plug(s) held securely in place anywhere along the channel(s) until the user desires to adjust or remove the coral plug.

### BACKGROUND OF THE INVENTION

### Field if the Invention

The invention relates to a coral holder that may reside in an aquarium, or be used for transport of corals inside a transport container. The invention may include channels to accept corals or coral plugs that are securely held in place along the channel.

### Background Art

The present invention relates to aquaria and in particular to a cost effective way of housing coral fragments. Saltwater reef keepers in particular may desire to keep or transport small to medium pieces of coral—a coral “frag.” For example, a hobbyist may purchase a coral or a frag at an aquarium (or reef keeping) store. The hobbyist may also trade with another lobbyist for one or more frags. Likewise, a store may purchase corals or frags from a distributor, a coral farm, or collectors. Because coral lives in water, and will die if exposed to air for extended periods, the hobbyist, store, distributor, or collector must find a way to transport the coral from one location to another while still in water. However, the roughness of transport can shatter a coral if it is not held securely.

A coral frag is a cut off piece of any type of coral. The frag is typically attached to a rock, a frag plug, or a place holder. Once cut and attached, the frag is placed into the aquarium to grow. Typically a frag is a preferred method of propagating corals—spreading the coral from one reef aquarium to another—due to the ability of the mother colony to retain its health and the inexpensiveness of a smaller frag as compared to trading large colonies. The variable sizes of coral frags and colonies present a transportation and storage problem, in that one size fits all coral transport methods aren't safe or effective for the corals.

The small frags, like a larger colony, must be safely transported from place to place. At present in the industry small frags may be placed into a small cup, with saltwater, and a lid screwed on. At other times a baggie may house the coral frag. The frag cup(s) may be placed inside a cooler to retain a proper temperature. Larger frags or colonies may be placed inside a larger bag and an insulated box, e.g., a polystyrene box. However, each of these methods leaves much to be desired in preventing the frag from knocking back and forth during transport.

As a result others have developed cups that have a more positive frag retention system. Early informal efforts included using egg crate lighting ceiling panels, which include a square grid pattern of openings. A frag plug, which is often a round post with a small disk on top, can slide into one of the openings. The frag, glued to the top of the disk, is then held some-what in place.

However, while an improvement this does not provide a secure hold on the frag plug, and thus, the frag. Thus, others have provided frag racks and transport containers with holes cut in a substrate. The hole is typically designed to be roughly the size of the frag plug, such that the frag plug is held more securely inside the hole in the frag rack. The substrate may be sized to fit within the container. For example, CoralVue Aquarium Products sells a container under the “IceCap Coral Frag Transport Container” that consists of a small container, a removable lid, and circular disk with 8 holes for frag plugs. Building an Obsession LLC sells a similar container.

However, these containers fail to provide secure transport for different sized frags. An owner may wish to transport small frags one day, and larger frags another day. Likewise, the owner may wish to transport or store multiple sized frags in the same frag container or frag rack. Because these frag racks provide a one size fits all solution for holding frags, with little placement flexibility, these frag racks cannot accomplish this. Thus, it would be advantageous to have a frag container or a frag rack that can accommodate different sized frags, with the flexibility to move the frags as needed. In addition, placement flexibility allows for noxious/stinging corals to be separated from those they would damage.

### BRIEF SUMARY OF THE INVENTION

The present invention solves these needs by providing a frag retention system that includes frag rack. The frag rack includes a base layer that has a first base layer slot, the base layer slot having a base layer slot length and a base layer slot width, where the length is at least two times the width. The frag rack also includes a retention layer that has a first retention layer slot, the retention layer slot having a retention layer slot length and a retention layer slot width, where the retention layer slot width is less than the base layer slot width. The frag rack also includes a top layer, the top layer including a first top layer slot, the top layer slot having a top layer slot length and a top layer slot width, where the top layer slot length is at least two times the top layer slot width. Typically the top layer slot length is substantially the same as the base layer slot length.

In one embodiment, the slot is diagonally arranged with respect to the base layer's widest cross section. In another embodiment the slot is curved. In still another embodiment, the slot is L shaped.

The frag retention system can include a container and a lid, the container and the lid being large enough to hold the frag rack inside the container. In some embodiments the frag retention system includes a pillar adapted to hold the frag rack in a stable vertical position with respect to the container. The frag retention system can also include legs that space the frag rack off the bottom of the container

The slots of the frag retention system can have different sizes. In one embodiment the retention layer slot width is at least 25% less than the base layer slot width. In another embodiment the retention layer slot width is at least 50% less than the base layer slot width.

In one embodiment the frag retention system includes methods of holding the retention layer in place. For example, in one embodiment the system includes retention pieces between the top layer and the base layer, the retention pieces being adapted to secure the retention layer in place between the top layer and the base layer. In one embodiment the retention pieces are integral to the base layer. In another, the retention pieces are adhered to the base layer and the top layer.

In another embodiment the frag retention system includes an adhesive inserted between the top layer and the base layer, the adhesive being adapted to secure the top layer to the base layer. The adhesive may dry into solid format. It may dry into holes in the retention layer, securing the retention layer.

In other embodiment the frag retention system includes a mounting option. The mounting option can be a magnet, for example.

In another embodiment, the invention comprises a frag retention system that includes a frag rack. The frag rack has a base layer which includes a first base layer channel, the base layer channel having a base layer channel length and a base layer channel width, where the length is at least two times the length. The frag rack also includes a retention layer, that includes a first retention layer channel, the retention layer channel having a retention layer channel length and a retention layer channel width, where the retention layer channel width is less than the base layer channel width. The frag rack also includes a top layer that includes a first top layer channel, the top layer channel having a top layer channel length and a top layer channel width, where the top layer channel length is at least two times the top layer channel width. In this embodiment the top layer channel length is substantially the same as the base layer channel length.

In one embodiment the frag retention system includes a container and a container lid, the container and the lid being large enough to hold the frag rack inside the container. The system can further include a pillar adapted to hold the frag rack in a stable vertical position with respect to the container, and one of the base layer, the retention layer, or the top layer being sized with respect to the container to hold the frag rack in a stable horizontal position with respect to the container. In another embodiment the frag rack can be turned upside down and placed in the container. In some embodiments the frag retention system can include a frag plug comprising a stem and a disk, the stem sized to fit in a channel. In another embodiment the base layer channel length is at least three times the base layer channel length.

### BRIEF DESCRIPTION OF THE DRAWINGS

FIG. 1 is a partial perspective view of a prior art frag rack;

FIG. 2 is an exploded view of one embodiment of the frag retention system's components and container according to the present disclosure;

FIG. 3A is a view of one embodiment of a frag rack retention layer;

FIG. 3B is a view of one embodiment of a frag rack retention layer;

FIG. 3C is a view of one embodiment of a frag rack retention layer;

FIG. 3D is a view of one embodiment of a frag rack retention layer within a frag rack;

FIG. 3E is a view of one embodiment of a slot and a hole for one embodiment of a frag rack retention layer;

FIG. 4 is an exploded view of the layers of one embodiment of a frag rack;

FIG. 5 is an exploded view of the layers of one embodiment of a frag rack;

FIG. 6 is an exploded view of the layers of one embodiment of a frag rack;

FIG. 7 is an exploded view of one embodiment of the frag rack components;

FIG. 8 is an exploded view of one embodiment of the frag rack components;

FIG. 9 is an exploded view of one embodiment of the frag rack components;

FIG. 10 is an exploded view of one embodiment of the frag rack components;

FIG. 11 is a partial perspective view of one embodiment of an assembled frag rack;

FIG. 12A is an exploded view of one embodiment of a frag rack with multiple retention layers.

FIG. 12B is a partial perspective view of one embodiment of an assembled frag rack with multiple frag racks.

### DETAILED DESCRIPTION OF THE PREFERRED EMBODIMENTS

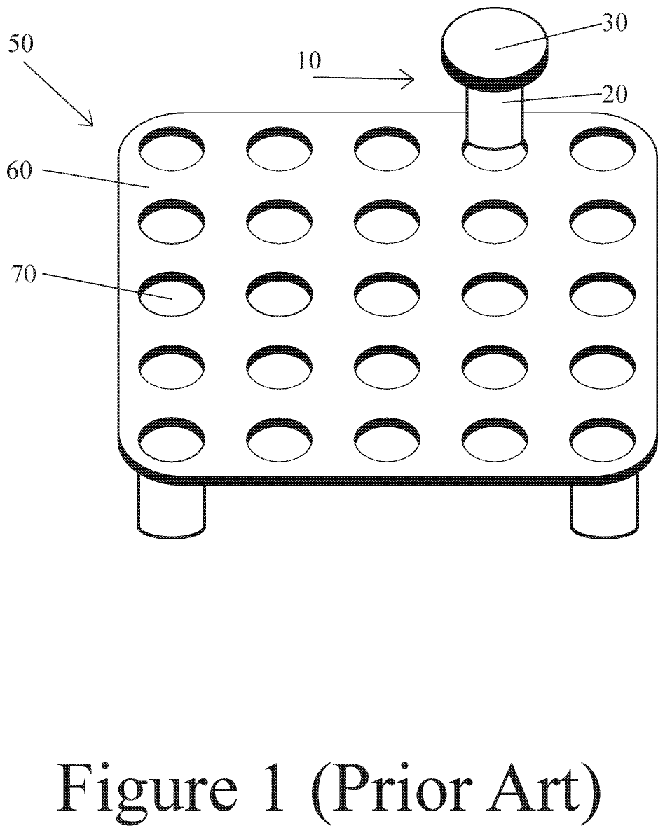

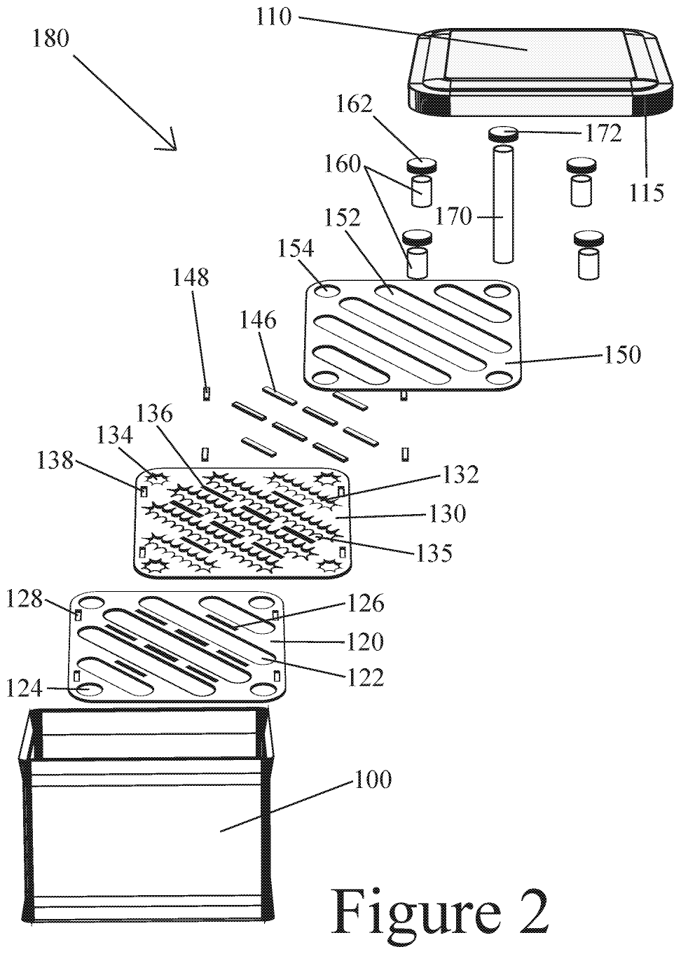

In general, the invention comprises a frag rack 180 that allows for many different sized coral frags and plugs to be securely and safely transported. See FIG. 2. Coral frags are often attached to a “frag plug” 10 (See FIG. 1). The frag plug 10 typically consists of a stem 20 and disk 30. The disk 30 may be round or square, irregular, concave, rock like, or any other suitable shape for attaching a coral frag. The stem is typically cylindrical, but can be square or have another cross sectional shape. Common frag plug stem sizes include ⅜″, ½″. ⅝″, and ¾″. The frag plug diameter is typically between ½″, ¾″, 1″, 1 ½″ & 2″ wide. The frag plug 10 may be constructed of ceramic, sand, glass, acrylic, or any other material. A circular disk 30 may have, for example, a ½″ diameter, ¾″ diameter, 1″ diameter, 1 ¼″ inch diameter, 2″ diameter, etc. A square disk 30 may have a 1″ side, 2″ side, etc. Generally the disk should have a larger diameter than the stem and preferably a larger diameter than the holes in the frag rack, so that when the frag plug is placed into a frag rack, the stem slides in, while the disk is too wide for the hole, resting on top of the rack. The disk is usually, but not always, flat on the top surface. Other disks 30 lack a stem 20 entirely, consisting entirely of a disk or square 30. Other frag plugs 10 can be conical. Still other frag plugs can be hollowed out in the middle,

As the size of a frag plug can vary so widely, a frag rack preferably can accommodate a wide variety of shapes and sizes. However, to securely hold a frag in place, the frag rack should have holes that grip the frag plug 10's stem 20 as closely as possible. Thus, a frag rack 50 (see FIG. 1) may have a base 60 formed of acrylic or other rigid material. Holes 70 are formed in the base 60. The hole diameter should be only slightly larger than the frag plug stem 10 to be used. However, as the manufacturer may not know which frag plug the customer will use, the holes 70 may need to be larger than ideal, and thus the frag is not as secure. During transport the frags may come loose, tumble in the container, and break. Even once it is placed inside an aquarium, where the frag rack is not moved regularly, a loose frag may be dislodged by current or by fish, and be broken. Thus, there is a tradeoff between these functionalities: holding any sized frag plug used, and securely holding the frag.

In addition, the prior art frag rack with holes does not provide a great deal of flexibility in frag placement. The frag must go exactly into an existing hole. In a large commercial system, the design can offer a degree of flexibility by simply drilling hundreds of holes 70 in the base 60. While this approach offers flexibility, it lacks elegance, and it can't be effectively used in a smaller frag rack or in a small portable frag container. In these situations, if the frag or frags cannot be orderly placed into the predrilled holes, the frag is likely to be left behind, broken, or placed into close contact with a competing frag that may harm or attempt to kill it.

In one embodiment of the present invention the frag system includes a frag rack 180 mounting option, such as container 100, with lid 110. See FIG. 2. Lid 110 may be sealed to container 100 with a sealing means 115, such as one or more of gravity, friction, locking mechanism, vacuum, twist locks, threaded attachments, latches, seals, such as a silicon seal, adhesives, gaskets, or other means known in the art. Preferably all materials used are considered reef safe, that is the materials used are at a minimum nontoxic to corals and other aquarium life, and preferably are inert in and unaffected by salt water.

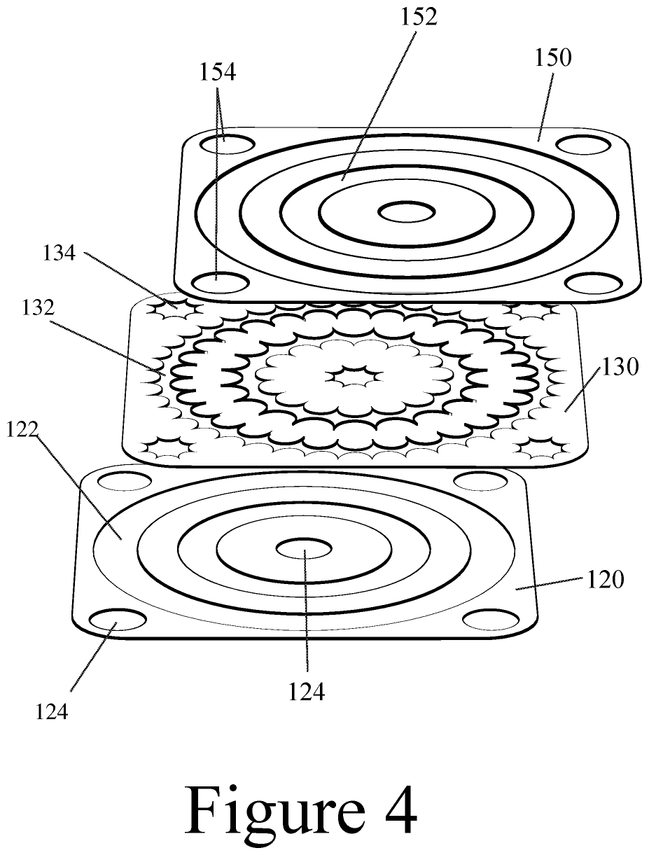

The frag system further includes a base 120. Base 120 is preferably formed from an inert material. Examples include acrylic, polycarbonate, ABS, printed ABS, glass, silicon, neoprene, rubber, PVC, epoxy, enamels, ceramics, plastic, additive printing materials, or stainless steel. Base 120 has a cutout pattern. The pattern includes one or more channels or slots 122 and may include one or more holes 124. Whereas the holes 124 typically have a substantially circular shape, and thus the width and length are the same (e.g., the diameter of the circle), the slots 122 are elongated, and thus the width and length are not the same. The width of the slots 122 may be the same as the diameter of the holes 124, and both may be sized to accommodate a frag plug base 20. Alternatively, the width of the slots 122 and holes 124 may be larger than the frag plug base 20. For example, the diameter of the hole 124 may be ½″, or maybe ⅝″, and thus able to accommodate most frag plugs. The slots 122 may be the same size as the holes 124. In some embodiments the slots 122 may be thinner than the diameter of the holes 124. The slots 122 may be ½″, or maybe ⅝″ wide. In other embodiments the slots may be thicker than the holes 124. The length of the slots will be larger than the width. In one embodiment the slot is twice as long as the width. In a curved slot a curve arc that is drawn through the center of the slot would be longer than the width of that slot. As used herein, the length of the slot 122 includes such a curved, circular, or wavy arc. In another embodiment the length of the slot 122 could be 3 times the diameter of the hole 124 (see FIG. 2). In another embodiment, the length of the slots may vary, e.g., one slot could be twice or three times the diameter, while another is 4, 5, or 6 times the diameter of the hole 124 or the width of slot 122. In still another embodiment, the “length” of the slot 122 is essentially perpetual. See FIG. 4.

In a preferred embodiment, the base 120 further includes depressions 126, and cutouts 128. Cutouts 128 could be sized to accommodate a coral frag that is not mounted on a frag plug. In this case, the cutout may be a small fraction of the size of hole 124, such as ⅛″. In a preferred embodiment, the depressions or cutouts can be sized to receive retention pieces 146, 148, or a glue/adhesive as described below.

The frag system further includes a retention layer 130. The retention layer may be made of silicon, e.g., 0.5-3.0 mm thick silicon, rubber, or another pliable material, such as rubber, neoprene, or a similar material. One preferred material is a 1 mm thick silicon layer. Another preferred material is a 1 mm-1.7 mm thick silicon layer. Another is a high durometer rubber material. In one embodiment the durometer of the silicon or rubber material is 70. In some embodiments the material chosen for the retention layer will depend on the material chosen for the base 120 or top layer 150. That is, if a hard rubber is used for base 120, a softer rubber may be used for the retention layer, and the two layers reflowed or adhered together to seal them in relative place. Other retention layers may be chosen for their ability to adhere to or be attached to the base 120 or top layer 150. The retention layer will have a series of holes 134 and channels or slots 132 that largely line up with the holes 124 and slots 122 in base layer 120.

As the Inventor of the instant application has discovered, the more holes 134 and slots 132 that are present in retention layer 130, and the larger the slots 132 are, the more difficult retaining it in position will be. In a prior art device, the retention layer will not stay in place, and over time will slide out of location, and will fail to hold the corals in place. To solve this problem, the inventor has developed several novel methods of holding a retention layer in place.

In one embodiment, the retention layer may have depressions 136 and cutouts 138. The cutout 138 is a hole is cut through the retention layer. In this event, the cutout 138 allows the retention piece 146, 148 to be exposed to both the top layer 150 and the base 120, and thus adhered to both, if desired. The depression 136, on the other hand, is not cut all the way through the retention layer 130, and can retain the retention layer 130 in place by pressure, friction, adhesion, or the like. The depression 136 and retention piece 146, 148 may operate together to force a retention layer 130 into a depression or cutout on the base layer 120 or top layer 150, pinching it in place.

Retention pieces 146 and 148 may be placed into depressions 126, 136 and cutouts 128, 138, to secure retention layer 130 from sliding relative to base layer 120. Retention pieces 146, 148 may be affixed to base 120, retention layer 130, or top layer 150 through adhesive, pressure, friction, or other means. In use, retention pieces 146, 148 prevent retention layer 130 from sliding relative to base 120 or top layer 150. The larger the number of holes 134 or slots 132 are present, the more the retention layer wants to move, and thus the more retention pieces, or higher friction, or use of adhesive, will be necessary.

While FIG. 2 depicts retention pieces 146, 148 as holding the retention layer in place, other means are contemplated. For example, top layer 150 and/or bottom layer 120 may have a rough surface, dimples, spikes, or other protrusions to sink into the retention layer 130, grabbing it under pressure and holding it in place. Likewise, rivets, adhesives, or screws may be used to hold the retention layer 130 in place (not shown). Typically, if pressure is used a thicker top layer 150 and base layer 120 will be required to apply that pressure, and thus the layers 120, 150 may be substantially thicker than the retention layer 130. For example, a 3 mm thick top layer may be combined with a 3 mm base layer, with a 2 mm thick silicon layer between them. This would provide a roughly 8 mm thick frag rack. Thinner silicon layers may be used as well, such as a 1.5 mm or 1.0 mm layer, resulting in a thinner frag rack. As with using pressure, if screws are used to hold the layers together, the layers 120, 150 will need to be thick enough that the screw threading will be able to hold the layers together without stripping.

If adhesive is used rather than the pressure, the adhesive itself may add to the thickness of the device, but its use may allow for a thinner frag rack. With adhesive, the 3 mm thick top layer may still be combined with a 3 mm base layer, with a 2 mm thick silicon layer between them. This would provide a roughly 8.1 mm thick frag rack. However, due to no need for pressure, the top layer 150 and the bottom layer 120 will not need to be the same size. Thus, a 3 mm bottom layer 120 may be combined with a 2 or 1 mm top layer 150 (or vice versa). This may be combined with a silicon layer of the desired thickness (3 mm, 2 mm, 1 mm, etc.). Likewise, very thin layers may be used, such as a 1 mm or 0.5 mm layer 120, 150, with a 1.0 mm layer of silicon. The resultant frag rack would be much smaller and lighter, and use less material.

The frag system may optionally include a top layer 150. Top layer 150 may have channels or slots 152 and holes 154 that match the slots and holes in the other layers. It may likewise have depressions and cutouts matching the other layers (not shown).

The frag system may further have legs 160. Legs 160 may fit through holes 154, 134, 124. In this embodiment, the legs extend below the frag system sufficiently to allow standard frag plugs to fit all the way into the frag system and rest on the top layer, e.g., top layer 150 or base 120, depending on the embodiment. Legs 160 may have a top 162. In another embodiment the legs 160 may fit into a slot 152, 132, 122. In this embodiment, the legs can be moved as needed to clear space for a frag, and yet secure the base off the bottom of container 100. In one embodiment, the leg may have a varying diameter, such that the bottom portion of the leg is thicker and will not fit through the relevant hole or slot Likewise, the top portion of such a leg may be thicker, or the top 162 may prevent the leg from falling down through the hole or slot. A twist lock system may also be used to insert, twist, and hold the leg in place. Finally, the frag system may use extra frag plugs 10 in place of legs 160.

In some embodiments the extra frag plugs 10 or legs 160 are absent. In these embodiments the base 120, retention layer 130, and top layer 150 may be connected in one or more manners. The particular manner of holding the layers together will depend on the materials used in the layers. For example, a nylon screw (not shown) may be threaded between the layers. In a preferred embodiment multiple nylon screws, one at each corner, or in a pattern in the middle of the frag rack 180 may be used to retain the layers. A c-clip or other locking means may be used to hold the layers together. In one embodiment the top layer 150 and the base 120 are integral, constructed of the same material as one piece, reflowed into one piece, or otherwise merged into a single piece. In another embodiment, all three layers are integral, for example with additive printing. For example, while the top layer and the bottom layer are thicker, and thus ridged, the portion of the retention layer 130 that extends into the slot 122 or hole 124 to retain the frag plug may be the same or similar material, but thinner and thus more flexible.

In other embodiments glue is used to adhere one layer to the next. The specific glue will depend on the materials used. For example, in one embodiment, the top layer 150, base 120, retention pieces 146, 148, are all a PVC, and are held together with a PVC cement or PVC glue. In another, each layer is made of a thermoplastic polymer, and the layers are reflowed together.

In a preferred embodiment, the top layer 150, base 120, retention pieces 146, 148, are all acrylic, and are held together with an acrylic glue or adhesive, such as Weld-On 4™. The retention layer, e.g., a 1 mm silicon sheet, is held in place via the friction between the top layer 150 and base 120, and/or the retention pieces 146, 148. In use, if the silicon layer is not tightly retained, it will shift positions as frags are moved in and out, and will fail to achieve its purpose.

Retention layer 130 may be designed in many different manners. First, the cross sectional area and shape of the retention layer 130 can precisely match the cross sectional area and shape of base layer 120 or top layer 150. In another embodiment, the cross sectional area and shape of the retention layer 130 is slightly smaller than that of the base.

In one preferred embodiment, the cross sectional area and shape of the retention layer 130 is larger than that of the base 120 and the top layer 150. In one aspect of this embodiment, the retention layer 130 may have a cross section and shape that fits precisely into the container 100 to provide a sealed or press fit into the container, so that it provides horizontal or vertical stability to the frag rack 180 within the container 100. In other embodiments, the base 120 or top 150 may also fit precisely into the container 100. However, the nature of the softer materials typically used in the retention layer 130 may allow for a better fit, friction to prevent movement, and a more satisfying experience for the user. In another embodiment the container 100 has a ledge that the frag rack 180 rests on to keep it off the bottom, or a groove that the frag rack 180, or a portion thereof, slides into, or down, for a secure fit (not shown).

In a preferred embodiment, the hole 134 in retention layer 130 has a smaller diameter than the hole 124 in base 120. The slot 132 may also have a smaller opening than the slot in the base 122. This allows the frag plug stem 20 to slide easily into the rigid hole 124 or slot 122, but then retention layer hole 134 or slot 132 grips the frag plug stem 20, securing it. Because the present invention provides slots 122, 132, 152, the frag plug stem 20 may be inserted anywhere along the slot 122, will still be gripped and held by the retention layer 130, and will be safely retained and flexibly positioned depending on the size of the frag and the frag plug.

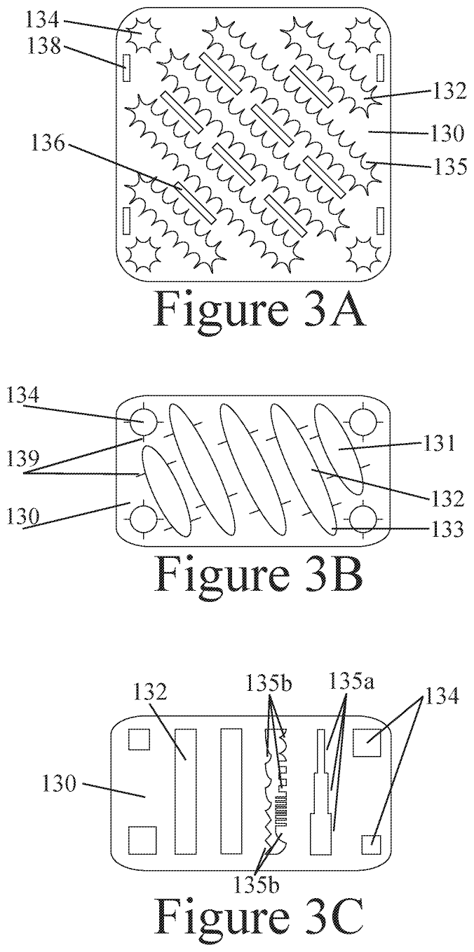

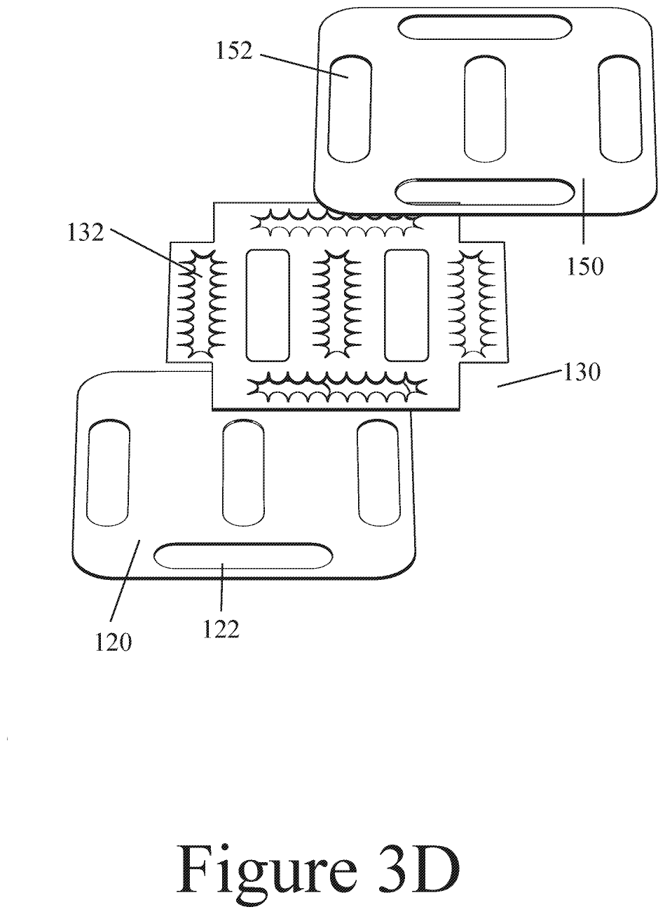

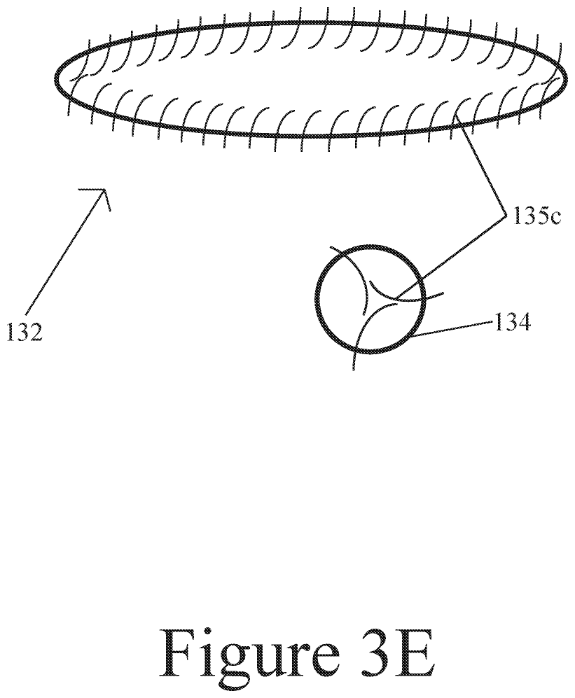

The holes and slots in 130 may take many forms, with the underlying goal of gripping the frag plug securely and adjustably. For instance, as shown in FIGS. 2 and 3A, a silicon layer 130 may have protrusions 135 that extend into the space of slot 132 or hole 130. The protrusions 135 may have any shape that effectively grips a frag plug 10. Thus, in the embodiment depicted in FIG. 3A, the protrusions have a semicircular shape. The protrusions may be connected, separate, or partially connected to each other. A similar effect can be achieved by, instead of protrusions, extending the entire retention layer 130 into the slot 122 or hole 124, and removing indentations (not shown) to allow the frag plug 10 space.

As shown in FIG. 3B, the retention layer 130 may have an oval cutout 132 that corresponds location wise with the slot 122. The oval cutout 132 may be wider in the middle 131, thus accommodating a larger diameter frag plug stem 20. The oval cutout may then be narrower at the ends 133, to accommodate a smaller diameter frag plug stem 20. Similarly, the slots 132 or holes 134 may have accompanying perforations or cuts 139 that allow the silicon layer to move to accommodate a frag plug stem 20.

As shown in FIG. 3C, the retention layer 130 may have other shaped slots, e.g., rectangular slot 132, and other shaped holes 134. The holes 134 may have different sizes to accommodate specialty frag plugs 10. The shapes may include rectangular, triangular, octagonal, irregular, and any other shape as needed. Protrusions 135a can also be rectangular, or can be in a wave pattern 135b. The rectangular protrusions 135a, as depicted, can create multiple widths for the frag plug stem 20, including a narrow opening on the ends, an intermediate opening, and a widest opening,. Likewise, the wave protrusions 135b can create any desired number of opening sizes. Protrusions 135b can take any effective shape, including rectangular, saw teeth, bristles, waves, and random shape, as depicted.

As shown in FIG. 3D, in another embodiment the cross sectional area of the retention layer does not resemble that of the base layer 120 or the top layer 150. For example, the retention layer 130 may only be present in the immediate vicinity of the holes 124 or channels 122. In this embodiment, the silicon retention layer provides some overlap along the channels 122, or the holes 124. That is, it extends into the channel or hole to grip the frag plug 10, and extends into the space between the top layer 150 and bottom layer 120 so that it can be retained in place. However, there are spaces between channels in the layers 120, 150 that do not have silicon. In one embodiment, these spaces include glue, or thicker portions of one of the layers 120, 150, to retain the silicon in place.

As shown in FIG. 3E, the retention layer may comprise inwardly extending arms or flanges 135c. Flanges 135c may extend out from the edge of retention layer 130's channel 132 or hole 134 in an arc. Flange 135 is designed to apply retention pressure to any thickness frag plug stem 20. That is, for a thicker frag plug stem 20, the flange will give way and be pressed up against the edge of the slot, hole or channel. For a thinner frag plug stem 20, the flange will press out toward the middle of the slot or hole, and retain the frag plug. Any of the protrusions 135 described herein may be shaped as either a flat sheet or as 3 dimensionally variable protrusion. However, flange 135c can be advantageously shaped as a slanted blade, such that the portion of flange 135c's arc that is in the middle, has a smaller height than that of the outside most portion, allowing the frag plug stem 20 to push it aside more easily, rather than bending it downward. Likewise, flange 135c can be shaped as a fan blade is, that is, rather than having a straight up and down vertical portion that is perpendicular to the face of base 120, top 150, or retention layer 130, it is slightly angled so that when a frag plug is pushed into it, the flange is not pushed straight down, but rather deflected.

With reference to FIG. 2, the system may also include a pillar 170, with a top 172. The pillar 172 can be sized to fit through a slot 122 or hole 124, or can be otherwise sized to fit through a hole specific to it. In a preferred embodiment, the pillar 170 works with legs 160, which hold the base 120 off the bottom of the frag container 100, to secure the frag rack 180 vertically in the container 100. That is, the legs hold the base 120 off the bottom of the container 100 (or the bottom of an aquarium), while the pillar holds the base 120 apart from the lid 110, when the lid 110 is secured in place. Thus, the frag rack 180 cannot move vertically, and the frags are prevented from bouncing during transport into the lid 110 or container 100. In another embodiment the pillar stretches between both the bottom of container 100 and the lid 110, and thus by itself holds the frag rack 180 vertically.

In still another embodiment, the pillar 170 and base 120 are respectively slidable relative to each other, and the height of the frag rack 180 may be adjusted to accommodate particular frags, or even a second frag rack 180, inside container 100. In this embodiment it can be preferred to have a locking mechanism to secure the pillar 170 in place, such as a slidable neoprene collar around pillar 170. Pillar 170 can double as a leg 160, and be combined with one or more legs 160.

In another embodiment the frag rack 180 can be removed from the container 100, have the frags added, and be reinserted upside down, so that the frags are facing downward rather than upward. Likewise, the same effect can be accomplished if legs 160 (or the bottom of pillar 170) are longer than the top of pillar 170. The frags could then be added to the bottom of the frag rack rather than the top. For the storage of some creatures, such as a sponge, which absolutely must remain submerged, upside down storage is a must, and this embodiment saves the user the trouble of inserting the sponge, adding the lid or cap, and flipping the container upside down, risking leaks.

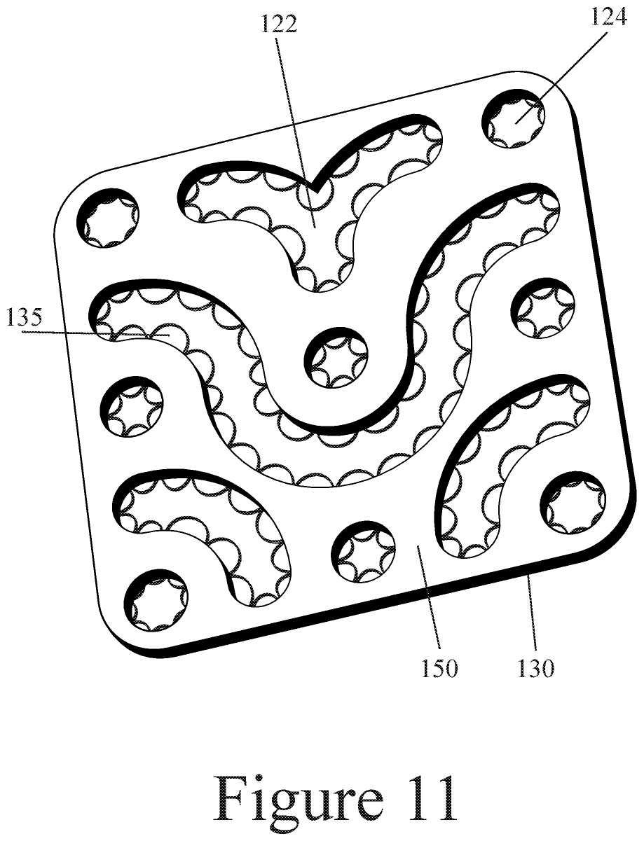

As shown in FIG. 4, the slots 122, 132, 152 can take any shape needed. As shown in FIG. 4, the slots may be circular. The holes 124, 134, 154, may be placed in any location, and in a preferred embodiment may be placed where there slots cannot reach in a particular layout, such as the corners and the middle of the FIG. 4 layout. As shown in FIG. 11, the slots 122 may take on any desired shape, need not be linear, or have any particular shape to them. In particular, in the present invention the length of the slot allows flexible frag placement along its length.

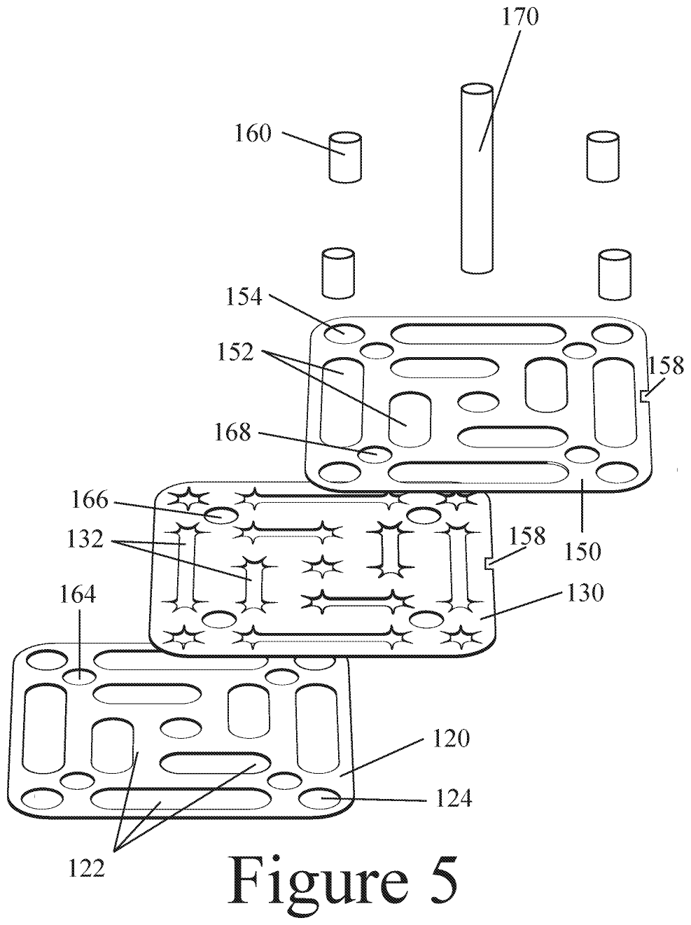

As shown in FIG. 5, the slots 122, 132, 152 can have varying lengths, depending on the shape of the container, the layers 120, 130, and 150. The holes 124, 154, may be placed in any location, and in a preferred embodiment may be placed where there slots cannot reach in a particular layout. In addition, leg holes 164, 166, and 168 may be specifically sized or located to hold legs 160. The base layer 120, retention layer 130, and top layer 150 may include one or more notches 158 to aid in aligning the layers properly.

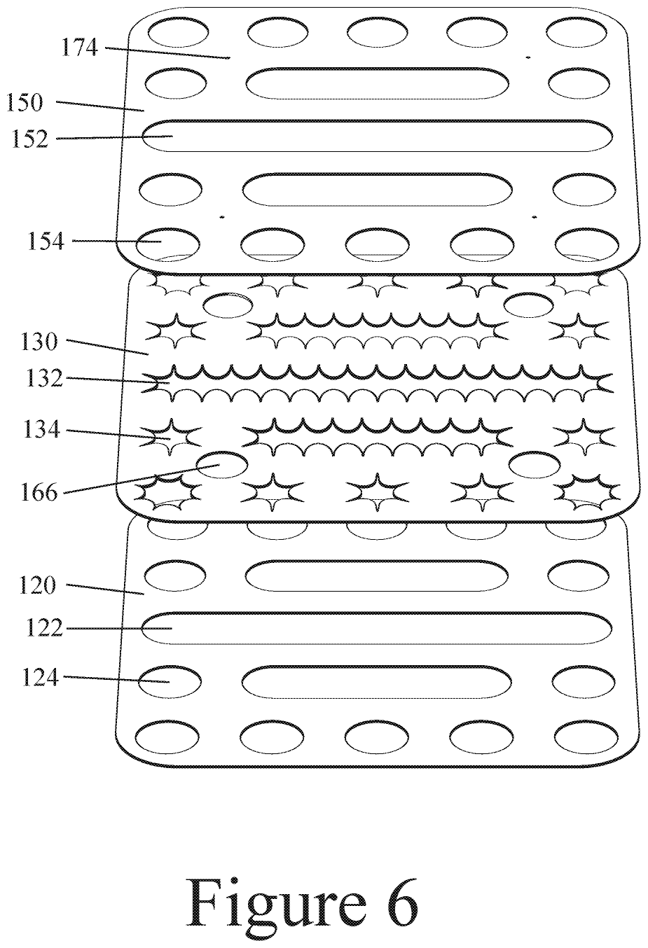

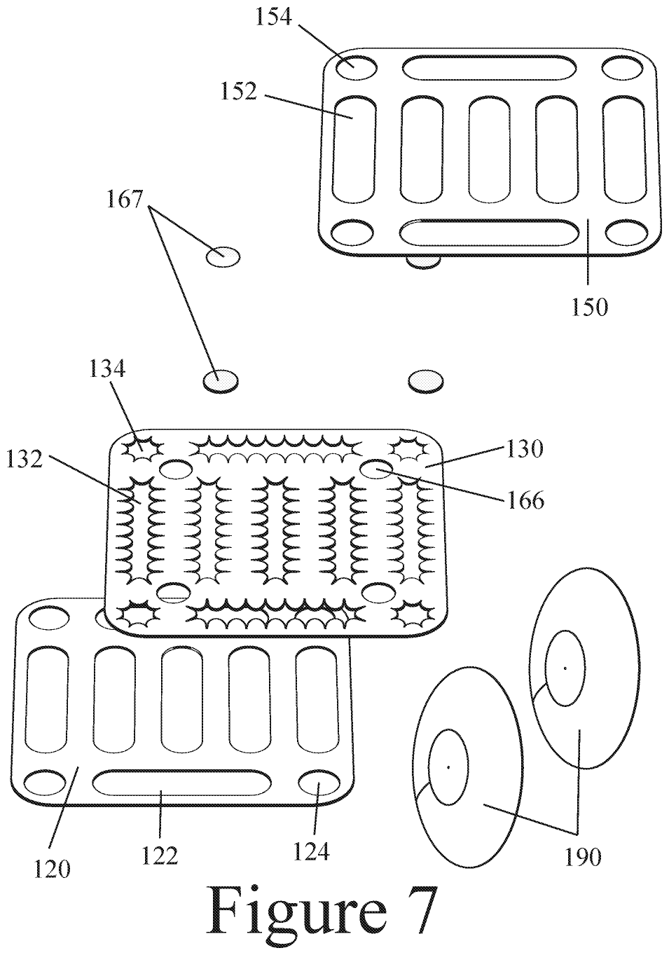

In another embodiment, shown in FIG. 6, leg holes 164, 168 may be absent. In this embodiment, only the retention layer 130 contains holes 166. As shown in FIG. 7, connectors 167 may sit in holes 166, and serve as a connection between the layers. For example, if top layer 150 and base 120 are acrylic, the connectors 167 may be an acrylic disk that is joined to the layers 120, 150 with an acrylic adhesive. In the alternative, connectors 167 may be absent, or may be an adhesive. Thus, the entire space may be filled with an acrylic adhesive to join the two layers together, as well as to hold the retention layer in place to prevent sliding. Top layer 150 may include glue holes 174 for inserting adhesive into the space 166 between the layers 120, 150, and 130. A thicker adhesive, such as Weld-On 16™, may be used to fill this space and join the layers 120, 150 together. Layer 130 may also be adhesively secured, or simply held in place by the presence of the connectors 167 or the adhesive. In one embodiment, the adhesive added through holes 174 and into space 166 will shrink as it hardens, thus adding force to pull layers 120, 150 together, to further secure retention layer 130 by pressure.

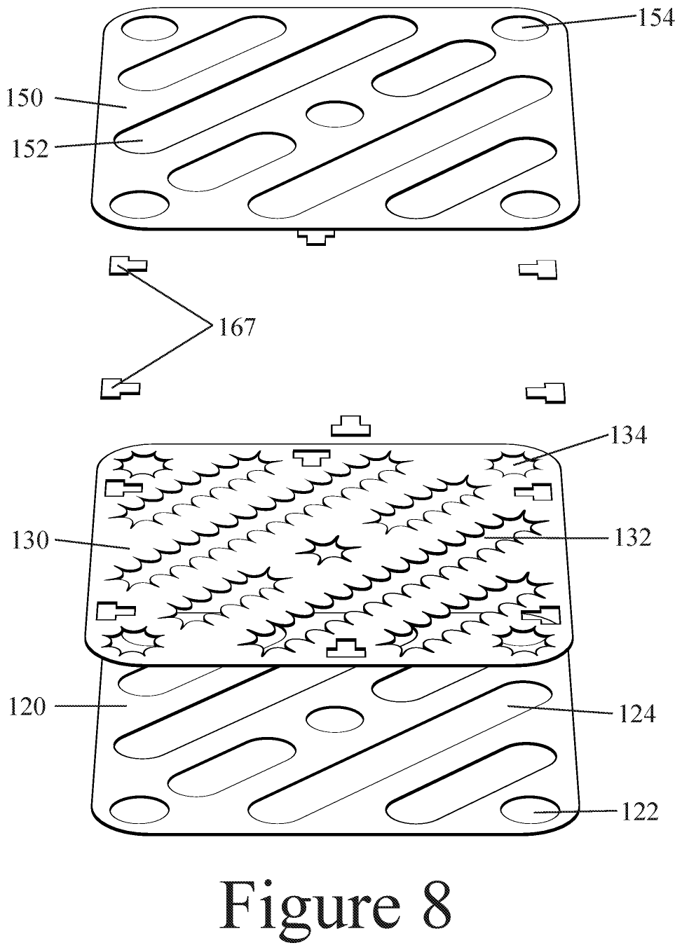

As shown in FIG. 8, the connectors 167 or the adhesive holes may assume any shape that is effective to either hold the layers together, or to hold the retention layer in place. Retention connectors 167 may also be replaced with magnets in each layer, or in the top layer 150 and base 120 to magnetically hold the layers together. Press connections may also be used to hold the layers together.

As shown in FIG. 7, the frag rack 180 may also include a mounting option, such as suction cups 190. Suction cups 190 can serve multiple purposes. First, suction cups 190 can secure the frag rack 180 inside container 100, either working by themselves to secure frag rack 180 to a side wall of container 100, or in conjunction with legs 160, pillar 170, or the cross sectional fit of the frag rack 180 into the container 100. Second, suction cups 190 can be used to allow frag rack 180 to be removed from container 100 and placed inside an aquarium, securing the frag rack 180 to the side glass of the aquarium, for example. In place of suction cups 190, the invention may use magnets (not shown) as a mounting option. In use, one magnet may be adhered to, or embedded within one or more layers on the frag rack 180. A second magnet may be placed outside the object the frag rack is to be attached to, e.g., outside the container 100 or aquarium, and the magnetic force mounts the frag rack in place. In a complete system, magnets may reside in various places and combinations. For example, a first magnet may be embedded within the frag rack. A second, complementary, magnet may be embedded in or attached to the container 100. When the frag rack 180 is in the container 100, the magnets line up the first and second magnets hold the frag rack 180 in place (not shown). A third magnet may be located on the outside of the aquarium. When the frag rack is removed from container 100 and placed into the aquarium, the first magnet (on frag rack 180) lines up with the third magnet (on the aquarium) and hold the frag rack in place on the aquarium. Of course, there may be multiple magnets in each of the three locations, designed to line up appropriately.

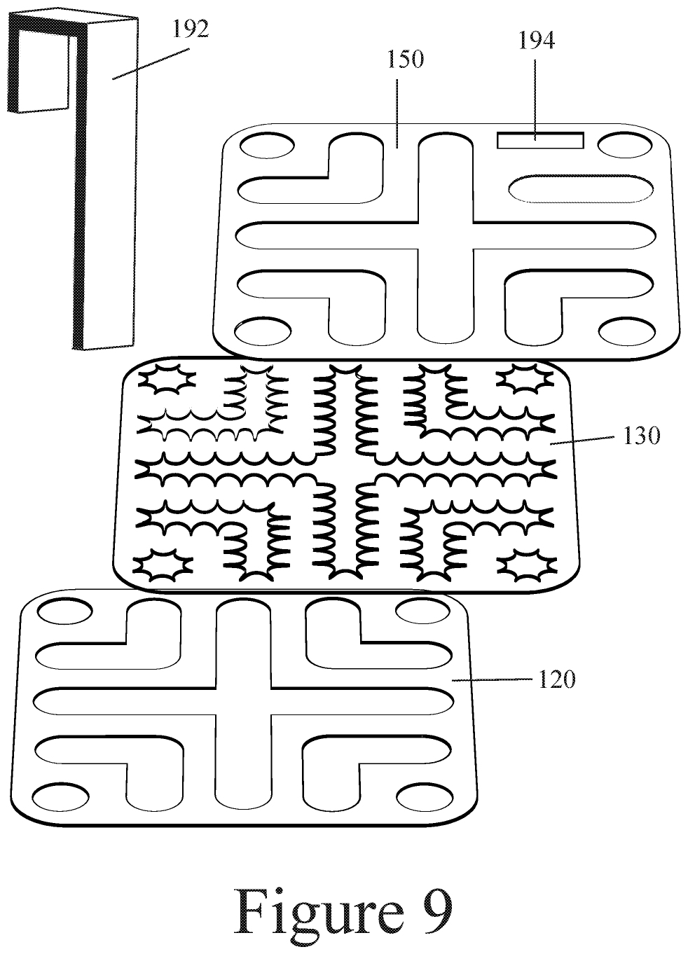

As shown in FIG. 9, a hanging clip 192 may slide into a slot 194 to retain the frag rack 180 in the aquarium or in container 100.

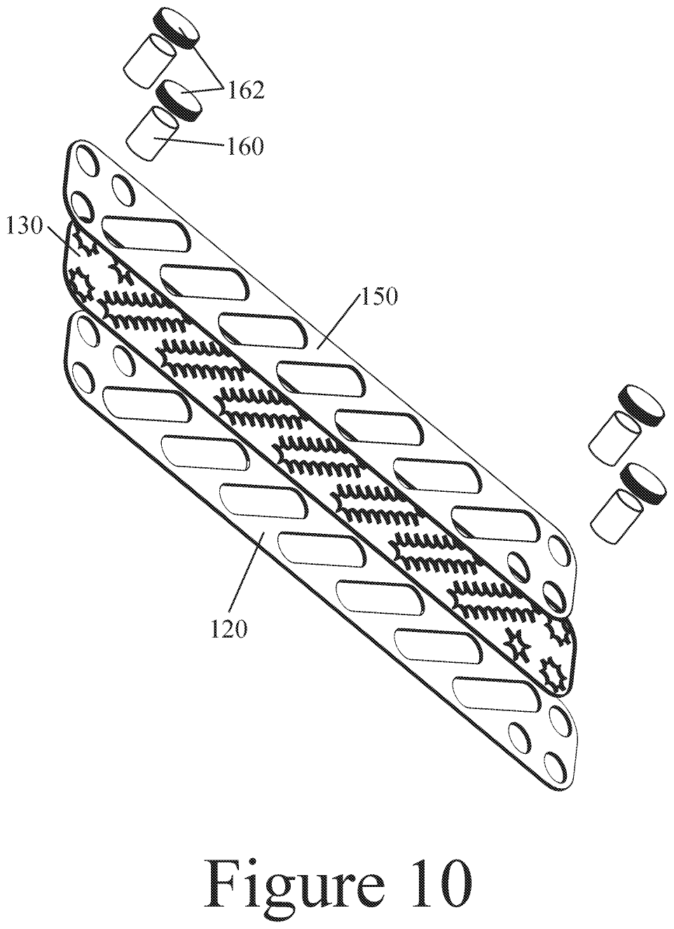

While the frag racks of the present invention have thus far been depicted as square, the frag rack can take any desired shape, from a rectangular shape depicted in FIG. 10, to a round shape, oval shape, triangular shapes, etc. The frag rack 180 should fit tightly inside the container 100, if present, or may be designed to fit inside a specific portion of an aquarium, e.g., a triangular frag rack 180 designed to fit inside a corner position of an aquarium.

As shown in FIG. 11, once assembled the top and bottom layer preferably are lined up together, to provide a neat appearance. The retention layer 130 may have a similar width and depth to the other layers, or may only cover a portion of the frag rack 180's cross section. In one embodiment the top layer 150 and the bottom layer 130 may have a different color or visual appearance. For example, one layer may be white, which allows the user to easily see certain coral pests, such as acro eating flat worms or red bugs. The other layer may be black, which allows the user to see other, lighter colored, pests. The user can then pick which layer will be on “top” to match the type of coral being placed, and thus the pests the user is most concerned with.

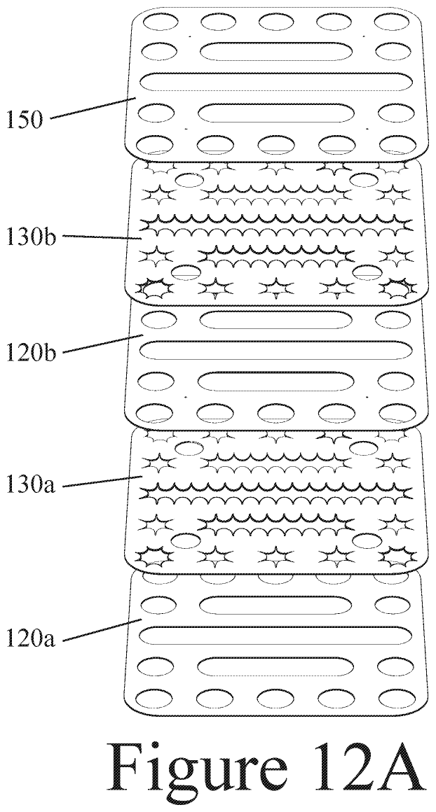

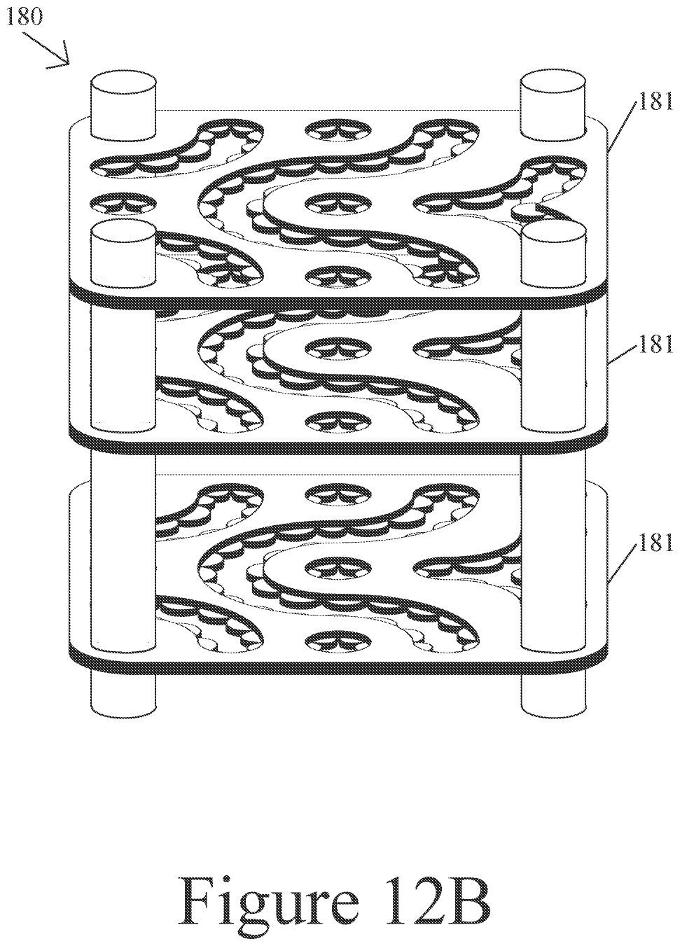

As shown in FIG. 12A, the frag rack 180 can include multiple retention layers 130a, 130b, which may be placed one on top of the other, or may alternate with the top layer(s) 150, or base layer(s) 120a, 120b. Providing multiple layers can provide a more secure retention of the coral and the frag plug 10. As shown in FIG. 12B, the frag rack 180 can include multiple frag rack layers 181. Each layer may have some combination of layers 120, 130, 150. In another embodiment, the frag rack 180 consists of only a base layer 120 and a retention layer 130 (not shown). The top layer 150 is absent. Likewise, the top layer 150 may be present, and the base layer 120 may be absent (not shown).

1. A frag retention system comprising:
A frag rack comprising:
a base layer, the base layer comprising:
a first base layer slot, the base layer slot having a base layer slot length and a base layer slot width, where the length is at least two times the width;
a retention layer, the retention layer comprising:
a first retention layer slot, the retention layer slot having a retention layer slot length and a retention layer slot width, where the retention layer slot width is less than the base layer slot width; and
a top layer, the top layer comprising:
a first top layer slot, the top layer slot having a top layer slot length and a top layer slot width, where the top layer slot length is at least two times the top layer slot width; and
wherein the top layer slot length is substantially the same as the base layer slot length.

2. The frag retention system of claim 1, wherein the slot is diagonally arranged with respect to the base layer's widest cross section.

3. The frag retention system of claim 1, wherein the slot is curved.

4. The frag retention system of claim 1, wherein the slot is L shaped.

5. The frag retention system of claim 1, further comprising a container and a lid, the container and the lid being large enough to hold the frag rack inside the container.

6. The frag retention system of claim 5, further comprising a pillar, the pillar adapted to hold the frag rack in a stable vertical position with respect to the container.

7. The frag retention system of claim 5, further comprising legs, the legs adapted to space the frag rack off the bottom of the container.

8. The frag retention system of claim 1 wherein the retention layer slot width is at least 25% less than the base layer slot width.

9. The frag retention system of claim 1 wherein the retention layer slot width is at least 50% less than the base layer slot width.

10. The frag retention system of claim 1 further comprising retention pieces between the top layer and the base layer, the retention pieces being adapted to secure the retention layer in place between the top layer and the base layer.

11. The frag retention system of claim 10, wherein the retention pieces are integral to the base layer.

12. The frag retention system of claim 11, wherein the retention pieces are adhered to the base layer and the top layer.

13. The frag retention system of claim 10, wherein the retention pieces are an adhesive inserted between the top layer and the base layer, the adhesive being adapted to secure the top layer to the base layer.

14. The frag retention system of claim 1, further comprising a mounting option.

15. The frag retention system of claim 13, wherein the mounting option comprises a magnet.

16. A frag retention system comprising:
A frag rack comprising:
a base layer, the base layer comprising:
a first base layer channel, the base layer channel having a base layer channel length and a base layer channel width, where the length is at least two times the length;
a retention layer, the retention layer comprising:
a first retention layer channel, the retention layer channel having a retention layer channel length and a retention layer channel width, where the retention layer channel width is less than the base layer channel width; and
a top layer, the top layer comprising:
a first top layer channel, the top layer channel having a top layer channel length and a top layer channel width, where the top layer channel length is at least two times the top layer channel width; and
wherein the top layer channel length is substantially the same as the base layer channel length.

17. The frag retention system of claim 16, further comprising a container and a container lid, the container and the lid being large enough to hold the frag rack inside the container, the system further comprising a pillar, the pillar adapted to hold the frag rack in a stable vertical position with respect to the container, and one of the base layer, the retention layer, or the top layer being sized with respect to the container to hold the frag rack in a stable horizontal position with respect to the container.

18. The frag retention system of claim 16, where the frag rack can be turned upside down and placed in the container.

19. The frag retention system of claim 16, further comprising a frag plug, the frag plug comprising a stem and a disk, the stem sized to fit in a channel.

20. The frag retention system of claim 15, wherein the base layer channel length is at least three times the base layer channel length.
